(19) United States
(12) Patent Application Publication
(10) Pub. No.: US 2024/0104874 A1
(43) Pub. Date: Mar. 28, 2024

(54) GAP FILLING FOR THREE-DIMENSIONAL DATA VISUALIZATION

(71) Applicant: FARO Technologies, Inc., Lake Mary, FL (US)

(72) Inventors: Marco Campanella, Concesio (IT); Joachim Bank, Dresden (DE)

(21) Appl. No.: 18/447,617

(22) Filed: Aug. 10, 2023

Related U.S. Application Data
(60) Provisional application No. 63/410,012, filed on Sep. 26, 2022.

(51) Int. Cl. G06T 19/20; G06T 3/40

(52) U.S. Cl. CPC G06T 19/20; G06T 3/40; G06T 2219/2012

(57) ABSTRACT

Examples described herein provide a method that includes receiving three-dimensional (3D) data associated with an environment. The method further includes generating a graphical representation based at least in part on at least one of the 3D data. The method further includes filling in a gap in the graphical representation using downsampled frame buffer objects.

### CROSS-REFERENCE TO RELATED APPLICATIONS

This application claims the benefit of U.S. Provisional Patent Application Ser. No. 63/410,012, filed Sep. 26, 2022, and entitled “GAP FILLING FOR THREE-DIMENSIONAL DATA VISUALIZATION,” the contents of which are incorporated by reference herein in their entirety.

### BACKGROUND

Embodiments described herein relate to a system and method for optically scanning and measuring an environment, and in particular, to a system and method for generating a display image from a point cloud.

Metrology devices, such as laser scanners for example, may generate large volumes of coordinate data of points located on the surfaces of the scanned area. These types of devices may be used to generate three-dimensional models of an area, such as a home or building, a crime scene, or an archeological site for example. Often with these types of scans, the data may be acquired from multiple positions to capture all of the desired surfaces and avoid having blank areas where a surface was in the “shadow” of another object. As a result in several data-sets of coordinate data are generated that are registered together to define a single data-set, sometimes colloquially referred to as a “point cloud” since the data is represented as a group of points in space without surfaces.

It should be appreciated that from a graphical display of a point cloud, it may be difficult to visualize the surfaces of the scanned area. This is due to the close proximity of points (from any user point of view) within the point cloud that may lie on different planes. For example, if the user point of view of the point cloud is looking down on a table, there will be points within the field of view from the table surface, along with the floor that is underneath the table surface or even the surface on the underside of the table.

Where the point cloud is relatively dense, meaning that the points on a surface are dense, the generation of surfaces in the displayed image for visualizing the scanned area may be created, albeit computationally intensive. However, in some applications, the point cloud may have a lower density of points resulting in gaps in the data set between the points of the point cloud. As a result, it may be difficult to generate a desired displayed image.

Accordingly, while existing metrology devices and point cloud display systems are suitable for their intended purposes the need for improvement remains, particularly in providing a system for filling in pixels on a graphical display to generate a displayed image of a point cloud.

### BRIEF DESCRIPTION

In one exemplary embodiment, a method is provided. The method includes receiving three-dimensional (3D) data associated with an environment. The method further includes generating a graphical representation based at least in part on at least one of the 3D data. The method further includes filling in a gap in the graphical representation using downsampled frame buffer objects.

In addition to one or more of the features described herein, or as an alternative, further embodiments of the method may include computing the downsampled frame buffer objects.

In addition to one or more of the features described herein, or as an alternative, further embodiments of the method may include that the downsampled frame buffer objects comprise an original image, a 2×2 image, a 4×4 image, an 8×8 image, and a 16×16 image.

In addition to one or more of the features described herein, or as an alternative, further embodiments of the method may include determining whether a pixel is gap-fillable.

In addition to one or more of the features described herein, or as an alternative, further embodiments of the method may include that determining whether the pixel is gap-fillable is based at least in part on a depth bias.

In addition to one or more of the features described herein, or as an alternative, further embodiments of the method may include that the depth bias is based at least in part on a frustrum height and a vertical screen resolution.

In addition to one or more of the features described herein, or as an alternative, further embodiments of the method may include that determining whether the pixel is gap-fillable is based at least in part on pixels in proximity to the pixel.

In addition to one or more of the features described herein, or as an alternative, further embodiments of the method may include that filling in the gap in the graphical representation comprises blending neighboring colors and depths relative to a pixel.

According to an embodiment, a system is provide. The system includes a memory comprising computer readable instructions and a processing device for executing the computer readable instructions, the computer readable instructions controlling the processing device to perform operations. The operations include receiving three-dimensional (3D) data associated with an environment. The operations further include generating a graphical representation based at least in part on at least one of the 3D data. The operations further include filling in a gap in the graphical representation using downsampled frame buffer objects.

In addition to one or more of the features described herein, or as an alternative, further embodiments of the system may include that the operations further include computing the downsampled frame buffer objects.

In addition to one or more of the features described herein, or as an alternative, further embodiments of the system may include that the downsampled frame buffer objects comprise an original image, a 2×2 image, a 4×4 image, an 8×8 image, and a 16×16 image.

In addition to one or more of the features described herein, or as an alternative, further embodiments of the system may include that the operations further include determining whether a pixel is gap-fillable.

In addition to one or more of the features described herein, or as an alternative, further embodiments of the system may include that determining whether the pixel is gap-fillable is based at least in part on a depth bias.

In addition to one or more of the features described herein, or as an alternative, further embodiments of the system may include that the depth bias is based at least in part on a frustrum height and a vertical screen resolution.

In addition to one or more of the features described herein, or as an alternative, further embodiments of the system may include that determining whether the pixel is gap-fillable is based at least in part on pixels in proximity to the pixel.

In addition to one or more of the features described herein, or as an alternative, further embodiments of the system may include that filling in the gap in the graphical representation comprises blending neighboring colors and depths relative to a pixel.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for gap filling for 3D data visualization according to one or more embodiments described herein;

FIG. 6 depicts a flow diagram of a method for gap filling for 3D data visualization according to one or more embodiments described herein;

FIG. 7 depicts a flow diagram of a method for gap filling for 3D data visualization according to one or more embodiments described herein;

FIGS. 8A and 8B depict representations according to one or more embodiments described herein; and

FIG. 9 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

One or more embodiments described herein relate to gap filling for 3D data visualization.

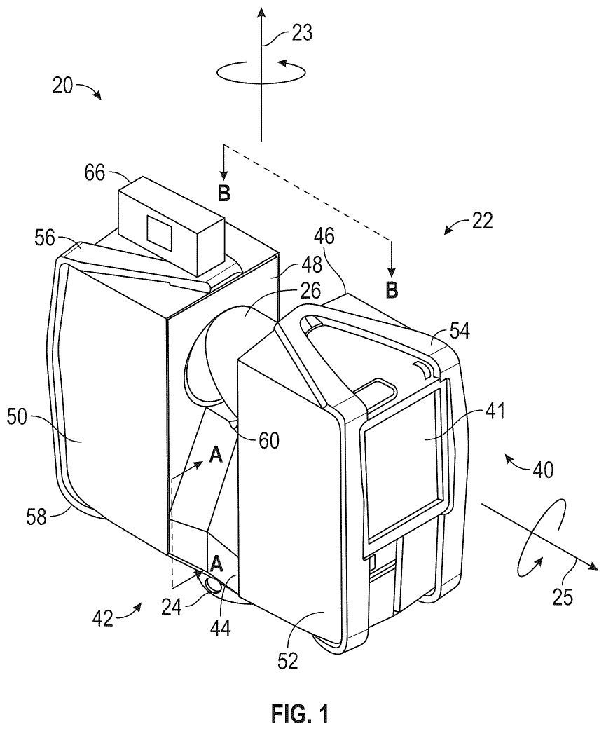

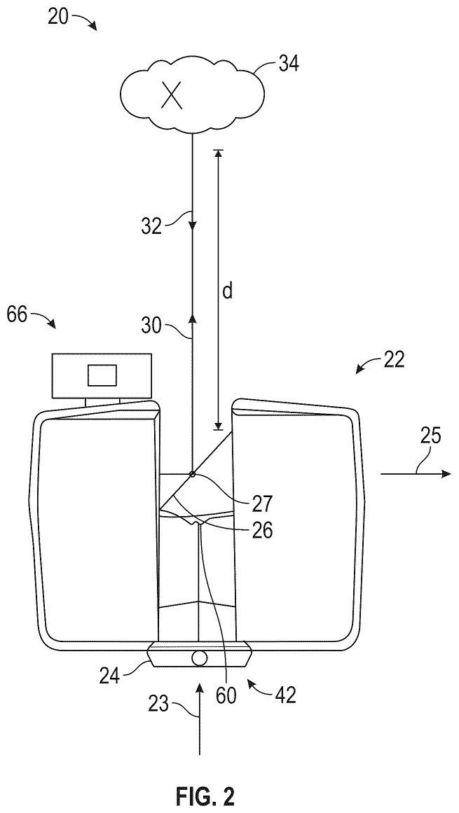

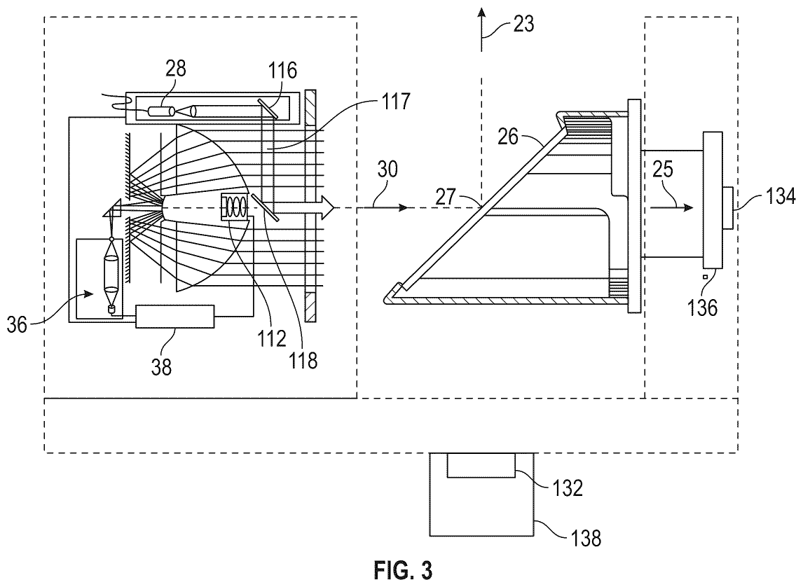

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary minor 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary minor 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary minor 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the minor is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

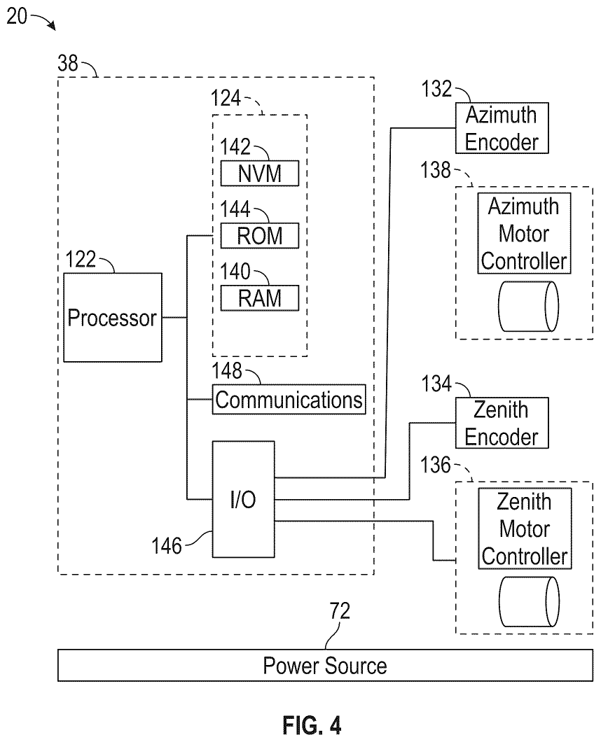

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes) 82, an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well- known computer communications protocol such as TCP/IP (Transmission Control Protocol/Internet(\hat{ } ) Protocol), RS-232, ModBus, and the like. Additional laser scanners 20 may also be connected to LAN with the controllers 38 in each of these laser scanners 20 being configured to send and receive data to and from remote computers and other laser scanners 20. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/0) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device may be another type of system that measures a plurality of points on surfaces (i.e., generates a point cloud), such as but not limited to a triangulation scanner, a structured light scanner, or a photogrammetry device for example.

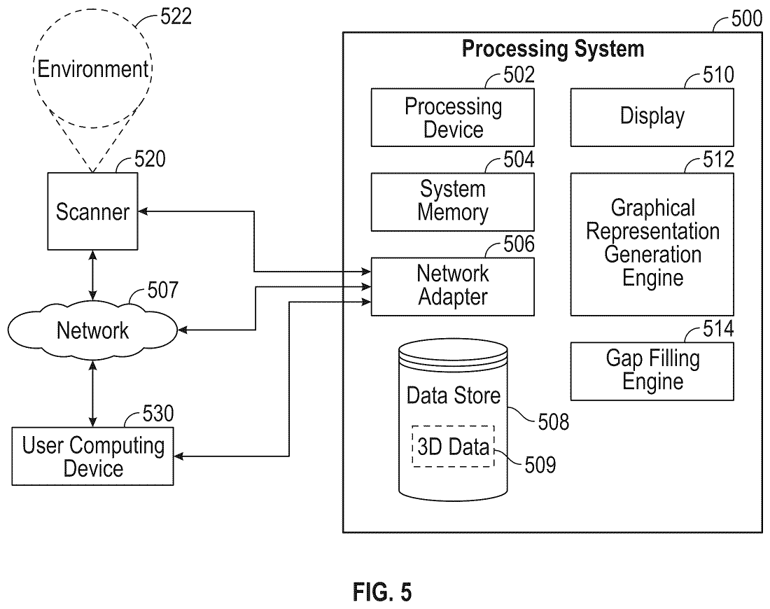

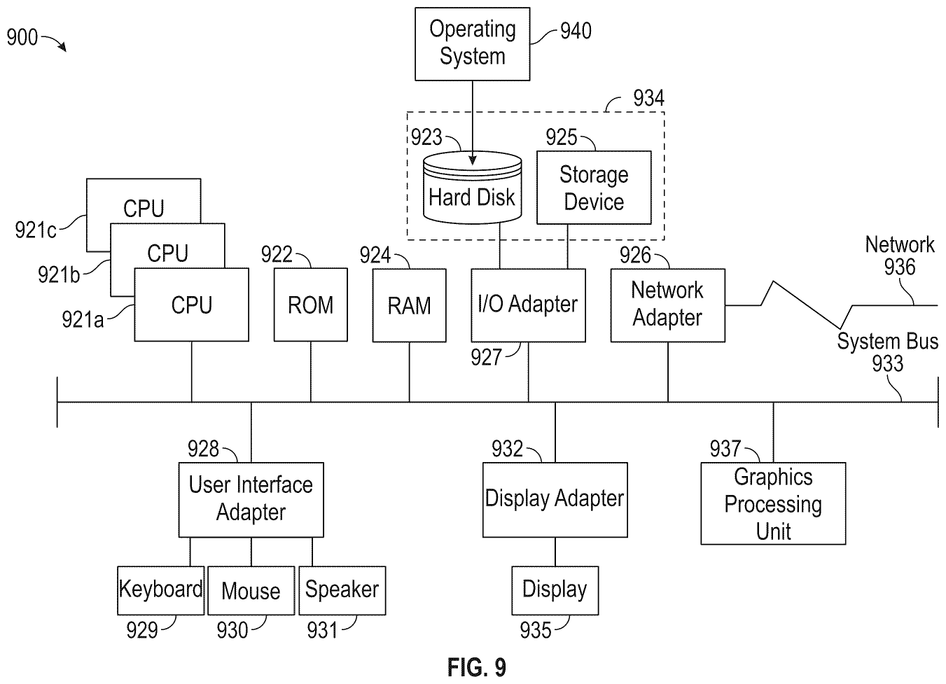

Referring now to FIG. 5, a schematic illustration of a processing system 500 for gap filling for 3D data visualization is shown according to one or more embodiments described herein. As described herein, gap filling refers to filling in pixels on a graphical display to generate a displayed representation of a point cloud. The processing system 500 includes a processing device 502 (e.g., one or more of the processing devices 921 of FIG. 9), a system memory 504 (e.g., the RAM 924 and/or the ROM 1022 of FIG. 9), a network adapter 506 (e.g., the network adapter 925 of FIG. 9), a data store 508, a display 510, a graphical representation generation engine 512, and a gap filling engine 514. The processing system 500 can be any suitable processing system, such as a smartphone, tablet computer, laptop or notebook computer, node(s) of a cloud computing system, etc.

The various components, modules, engines, etc. described regarding FIG. 5 (e.g., the graphical representation generation engine 512 and the gap filling engine 514) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 502 for executing those instructions. Thus, the system memory 504 can store program instructions that when executed by the processing device 502 implement the engines described herein. Other engines can also be utilized to include other features and functionality described in other examples herein.

The network adapter 506 enables the processing system 500 to transmit data to and/or receive data from other sources, such as the scanner 520. For example, the processing system 500 receives data (e.g., a data set that includes a plurality of three-dimensional coordinates of an environment 522) from the scanner 520 directly and/or via a network 507. The data from the scanner 520 can be stored in the data store 508 of the processing system 500 as 3D data 509, which can be used to display a point cloud or other graphical representation on the display 510. The scanner 520 can be the same or similar to the scanner 20 of FIGS. 1-4 according to one or more embodiments described herein.

The network 507 represents any one or a combination of different types of suitable communications networks such as, for example, cable networks, public networks (e.g., the Internet), private networks, wireless networks, cellular networks, or any other suitable private and/or public networks. Further, the network 507 can have any suitable communication range associated therewith and may include, for example, global networks (e.g., the Internet), metropolitan area networks (MANs), wide area networks (WANs), local area networks (LANs), or personal area networks (PANs). In addition, the network 507 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The scanner 520 (e.g., a laser scanner) can be arranged on, in, and/or around the environment 522 to scan the environment 522. It should be appreciated that while embodiments herein refer to a 3D coordinate measurement device as a laser scanner (e.g., the scanner 520), this is for example purposes and the claims should not be so limited. In other embodiments, other types of optical measurement devices may be used, such as but not limited to triangulation scanners and structured light scanners for example.

According to one or more embodiments described herein, the scanner 520 can include a scanner processing system including a scanner controller, a housing, and a three-dimensional (3D) scanner. The 3D scanner can be disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The scanner 520 performs at least one scan to generate a data set (e.g., the 3D data 509) that includes a plurality of three-dimensional coordinates of the environment 522. It should be appreciated that other numbers of scanners (e.g., one scanner, three scanners, four scanners, six scanners, eight scanners, etc.) can be used. According to one or more embodiments described herein, one or more scanners can be used to take multiple scans. For example, the scanner 520 can capture first scan data of the environment 522 at a first location and then be moved to a second location, where the scanner 520 captures second scan data of the environment 522.

Using the data received from the scanner 520, the processing system 500 can generate a graphical representation based on the 3D data 509 using one or more of the gap filling engine 514 and the graphical representation generation engine 512. For example, the gap filling engine 514 performs fills gaps within the 3D data 509 as described herein. The graphical representation generation engine 512 generates a graphical representation of the 3D data 509 for display on the display 510 and/or on display of another device/system. For example, in an embodiment where the processing system 500 is a node of a cloud computing system, the graphical representation generation engine 512 can generate a graphical representation to be displayed on a user computing device 530 (e.g., such as a smartphone, tablet computer, laptop or notebook computer, a wearable device such as a head-up display or smartwatch, and/or the like, including combinations and/or multiples thereof).

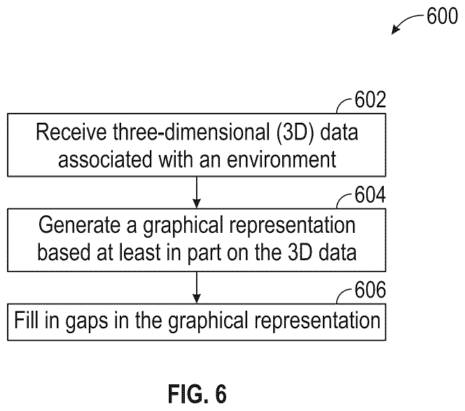

Turning now to FIG. 6, a flow diagram of a method 600 for gap filling for three-dimensional data visualization according to one or more embodiments described herein. The method 600 can be performed by any suitable system or device, such as the processing system 500 of FIG. 5 and/or the processing system 900 of FIG. 9.

At block 602, a processing system (e.g., the processing system 500) receives 3D data (e.g., 3D data 509) associated with an environment (e.g., the environment 622). The 3D data 509 can be captured by any suitable 3D coordinate measurement device, such as the scanner 20 of FIGS. 1-4, the scanner 520 of FIG. 5, and/or the like, including combinations and/or multiples thereof. According to an embodiment, the 3D data 509 includes one or more point clouds, which are collections of points having 3D coordinates (e.g., “x,y,z”) associated with the environment.

At block 604, the processing system (e.g., using the graphical representation generation engine 512) generates a graphical representation of the 3D data (e.g., the 3D data 509). For example, the graphical representation can be a graphical representation of a point cloud that is generated using the 3D data. The graphical representation can be referred to as a “virtual camera” or “camera” which represents a view a “camera” would capture if placed in the environment.

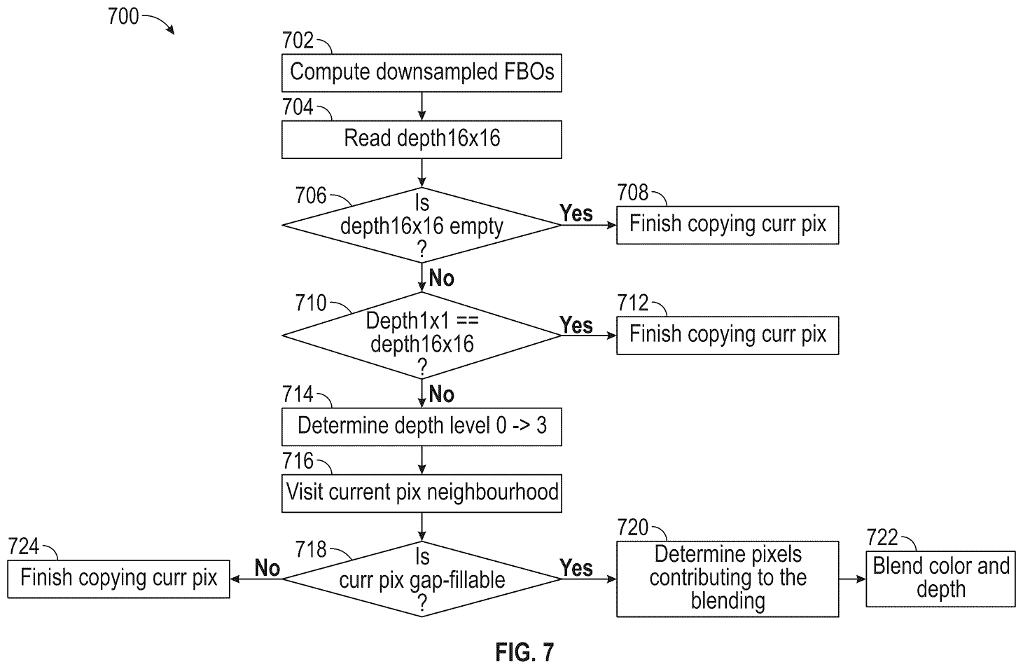

At block 606, the processing system (e.g., using the gap filling engine 514) fills in gaps in the graphical representation. A method for gap filling is illustrated in FIG. 7 and is further described herein.

It should be understood that the process depicted in FIG. 6 represents an illustration, and that other processes may be added or existing processes may be removed, modified, or rearranged without departing from the scope of the present disclosure.

FIG. 7 depicts a flow diagram of a method 700 for gap filling for three-dimensional data visualization according to one or more embodiments described herein. The method 700 can be performed by any suitable system or device, such as the processing system 500 of FIG. 5 and/or the processing system 900 of FIG. 9.

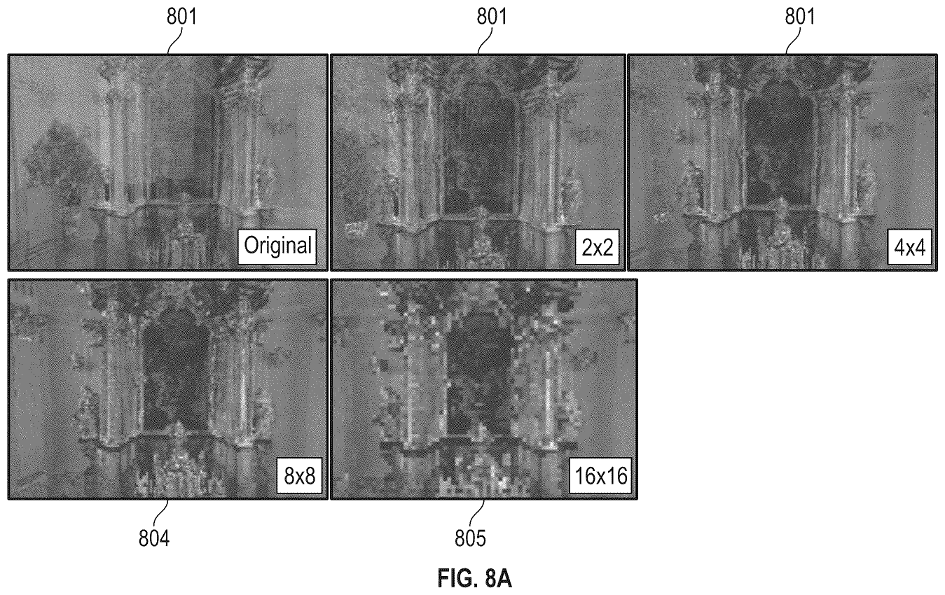

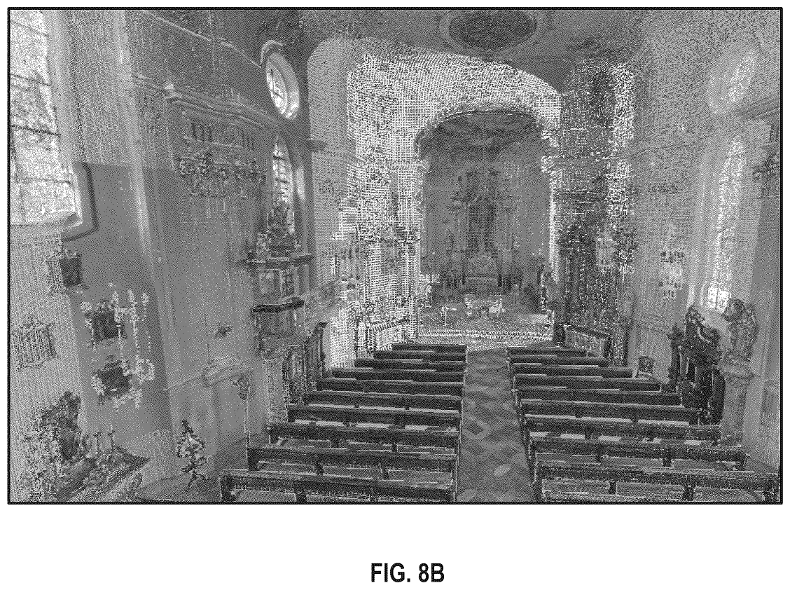

At block 702, the gap filling engine 514 computes downsampled frame buffer objects (FBOs). For example, as shown in FIG. 8A, the gap filling engine 514 can compute four downsampled FBOs from an original representation 801: 2×2 representation 802, 4×4 representation 803, 8x8 representation 804, 16×16 representation 805. In each pixel of the downsamped FBO representations, the following information is stored: the depth that is closest to the virtual camera (e.g., a center of a field of view of the graphical representation) and the color that is closest to the virtual camera.

At block 704, the gap filling engine 514 reads depth information from the 16×16 representation 805. At decision block 706, it is determined whether the depth information from the 16×16 representation 805 is empty. If so (“yes” at decision block 706), the method 700 proceeds to block 708 where the current pixel is copied over at block 708. If not, (“no” at decision block 706), the method 700 proceeds to decision block 710, where it is determined whether the depth information from the lx1 representation (e.g., the original representation 801) is equal to the depth information from the 16×16 representation 805. If not, (“yes” at decision block 710), the method 700 proceeds to block 712 where the current pixel is finished being copied at block 708. If not, (“no” at decision block 710), the method 700 proceeds to decision block 714, where the gap filling engine 514 determines a depth level. For example, depth of the pixel is read both in 1×1 resolution representation (e.g., representation 801) and in 16×16 resolution representation (e.g., representation 805). The 16×16 depth is used to classify the pixels into groups. For example, the pixels can be classified into four groups (see, e.g., FIG. 8B): red (farthest), yellow (medium), green, and cyan (closest to the camera). For each group, a specific neighborhood of the pixel is looked up at black 716. The neighborhood includes other pixels in proximity to (e.g., within a threshold distance, adjacent to, and/or the like, including combinations and/or multiples thereof) of a particular pixel. The neighborhood is used to determine, at decision block 718, whether the current pixel is gap-fillable. If the neighborhood forms a bridge that «jumps» the current pixel (“yes” at decision block 718), the current pixel can be filled. The method 700 proceeds to block 720 where is determined which pixels contribute to blending. At block 722, the gap filling engine 514 blends color and depth for the pixel. Otherwise (“no” at decision block 718), the current pixel is finished being copied, at block 724, to the output color and depth textures.

It should be understood that the process depicted in FIG. 7 represents an illustration, and that other processes may be added or existing processes may be removed, modified, or rearranged without departing from the scope of the present disclosure.

It is understood that one or more embodiments described herein is capable of being implemented in conjunction with any other type of computing environment now known or later developed. For example, FIG. 9 depicts a block diagram of a processing system 900 for implementing the techniques described herein. In accordance with one or more embodiments described herein, the processing system 900 is an example of a cloud computing node of a cloud computing environment. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/0) adapter 927 and a network adapter 926 coupled to system bus 933. I/0 adapter 927 may be a small computer system interface (SCSI) adapter that communicates with a hard disk 923 and/or a storage device 925 or any other similar component. I/0 adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display (e.g., a display monitor) 935 is connected to system bus 933 by display adapter 932, which may include a graphics adapter to improve the performance of graphics intensive applications and a video controller. In one aspect of the present disclosure, adapters 926, 927, and/or 932 may be connected to one or more I/0 busses that are connected to system bus 933 via an intermediate bus bridge (not shown). Suitable I/0 buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/0 chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method comprising:
receiving three-dimensional (3D) data associated with an environment;
generating a graphical representation based at least in part on at least one of the 3D data; and
filling in a gap in the graphical representation using downsampled frame buffer objects.

2. The method of claim 1, further comprising computing the downsampled frame buffer objects.

3. The method of claim 2, wherein the downsampled frame buffer objects comprise an original image, a 2×2 image, a 4×4 image, an 8×8 image, and a 16×16 image.

4. The method of claim 1, further comprising determining whether a pixel is gap -fillable.

5. The method of claim 4, wherein determining whether the pixel is gap-fillable is based at least in part on a depth bias.

6. The method of claim 5, wherein the depth bias is based at least in part on a frustrum height and a vertical screen resolution.

7. The method of claim 4, wherein determining whether the pixel is gap-fillable is based at least in part on pixels in proximity to the pixel.

8. The method of claim 1, wherein filling in the gap in the graphical representation comprises blending neighboring colors and depths relative to a pixel.

9. A system comprising:
a memory comprising computer readable instructions; and
a processing device for executing the computer readable instructions, the computer readable instructions controlling the processing device to perform operations comprising:
receiving three-dimensional (3D) data associated with an environment;
generating a graphical representation based at least in part on at least one of the 3D data; and
filling in a gap in the graphical representation using downsampled frame buffer objects.

10. The system of claim 9, the operations further including computing the downsampled frame buffer objects.

11. The system of claim 10, wherein the downsampled frame buffer objects comprise an original image, a 2×2 image, a 4×4 image, an 8×8 image, and a 16×16 image.

12. The system of claim 9, the operations further including determining whether a pixel is gap-fillable.

13. The system of claim 12, wherein determining whether the pixel is gap-fillable is based at least in part on a depth bias.

14. The system of claim 13, wherein the depth bias is based at least in part on a frustrum height and a vertical screen resolution.

15. The system of claim 12, wherein determining whether the pixel is gap-fillable is based at least in part on pixels in proximity to the pixel.

16. The system of claim 9, wherein filling in the gap in the graphical representation comprises blending neighboring colors and depths relative to a pixel.
